(19) United States
(12) Patent Application Publication
(10) Pub. No.: US 2007/0174786 A1
(43) Pub. Date: Jul. 26, 2007

(54) Computer-readable recording medium having recorded message display control program and message display control apparatus

(75) Inventors: Shinichi Doi, Kawasaki (JP); Takamasa Ohashi, Kawasaki (JP); Yuki Torii, Kawasaki (JP); Takahiro Inagaki, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/407,507

(22) Filed: Apr. 20, 2006

(30) Foreign Application Priority Data
Jan. 24, 2006 (JP) JP 2006-014779

(51) Int. Cl. G06F 3/00

(52) U.S. Cl. 715/808

(57) ABSTRACT

A computer-readable recording medium having recorded a message display control program for notifying that a message has been generated, without interfering with the operation of the user. A notification acceptance block accepts a notification that an event has occurred in a window and obtains notification information related to the event. A notification history message generation block generates a notification history message in accordance with the notification information stored in a notification information database. A window status confirmation block checks whether the window corresponding to the notification information is active. If the window is active, a pop-up message display block displays a pop-up message corresponding to the notification information on the screen. If the window is inactive, a notification icon display block displays a notification icon corresponding to the notification information of the window on the screen of the active window.

### CROSS-REFERENCE TO RELATED APPLICATIONS

This application is based upon and claims the benefits of priority from the prior Japanese Patent Application No. 2006-014779, filed on Jan. 24, 2006, the entire contents of which are incorporated herein by reference.

### BACKGROUND OF THE INVENTION

1. Field of the Invention

The present invention relates to computer-readable recording media having recorded a message display control program and message display control apparatuses, and particularly to a computer-readable recording medium having recorded a message display control program and a message display control apparatus for controlling the display of a message reporting an event occurring in a multi-window environment.

2. Description of the Related Art

In a conventional multi-window environment, in which a plurality of windows are displayed on the same basic screen, parallel data processing can be performed in those windows. If an error or the like occurs in data processing in the windows including inactive windows, a message window is displayed on the screen to inform the operator of the occurrence. The message window displayed in any place on the screen when an error or the like occurs is hereafter referred to as a pop-up message.

All the windows in the multi-window environment are operating, but the operator can perform input processing only in an active window having the input focus. The pop-up message appears irrespective of whether the related window is active or not and remains on the screen until the operator does something in response to the pop-up message. Therefore, the ongoing work can be interrupted.

A method proposed to prevent the interruption of the current operation displays a message display button informing the operator of the presence of a pop-up message in the title display field of the active window, instead of displaying the pop-up message, and displays a message window when the message display button is selected (refer to Japanese Unexamined Patent Application Publication No. Hei-10-21039 (paragraph numbers [0014] to [0021] and FIG. 1), for instance).

With the Operating System (OS) of Windows (registered trademark) 2000 or later, if the window for which the pop-up message is displayed is inactive, the pop-up message does not gain the focus from another window and the pop-up message window does not become active.

Another method provides an error message display button and an error message delete button on the screen and allows the error message to be displayed or hidden by clicking the corresponding button (refer to Japanese Unexamined Patent Application Publication No. Hei-5-216612 (paragraph numbers [0008] to [0009] and FIG. 1), for instance).

If a pop-up message appears unconditionally and if the pop-up message is related to an inactive window, the active window will lose the focus or will be overlaid by the pop-up message, causing the ongoing work of the operator to be interrupted. If the active window keeps the focus, the pop-up message would be hidden behind the active window, and the operator would miss the pop-up message display (the occurrence of an error or the like). The window corresponding to the pop-up message stops its processing when the pop-up message appears, so that the processing stops until the operator becomes aware of and closes the pop-up message.

In the method in which the error message display button or the error message delete button is used to display or hide the error message, if the mode to hide the error message is selected, an important error message will not be given to the operator, and the operator cannot be aware of any interruption of the processing.

If the message display button is displayed in the title display field of the active window in order to inform the operator of the presence of a pop-up message, the message display button indicates that there is a message, but the operator must check the message to see whether the message requires an immediate action. The operator, who cannot miss an important message, must check the message each time the message display button appears, interrupting the processing each time.

### SUMMARY OF THE INVENTION

In view of the foregoing, it is an object of the present invention to provide a computer-readable recording medium having recorded a message display control program and a message display control apparatus for informing the user of the occurrence of a message together with its severity and urgency without interfering with the user's operation.

To accomplish the above object, according to the present invention, there is provided a computer-readable recording medium having recorded a message display control program for performing display control processing of a message reporting an event which has occurred in a multi-window environment. This message display control program recorded on the recording medium causes a computer to function as the following: a notification acceptance block for accepting a notification that a certain event has occurred in a window processing block for executing processing related to a window and obtaining notification information related to the event, generated by the window processing block; a notification history message generation block for generating a notification history message reporting the event which has occurred in the window, in accordance with the notification information; a window status confirmation block for checking whether the window for which the notification acceptance block has obtained the notification information is active; a pop-up message display block for displaying a pop-up message corresponding to the notification information related to the window if the window status confirmation block confirms that the window is active; and a notification icon display block for displaying a notification icon corresponding to the notification information of the window on the screen of the active window if the window status confirmation block confirms that the window is inactive.

To accomplish the above object, according to the present invention, there is also provided a message display control apparatus for performing display control of a message reporting an event which has occurred in a multi-window environment. This message display control apparatus includes the following elements: a notification acceptance block for accepting a notification that a certain event has occurred in a window processing block for executing processing related to a window and obtaining notification information related to the event, generated by the window processing block; a notification history message generation block for generating a notification history message reporting the event which has occurred in the window, in accordance with the notification information; a window status confirmation block for checking whether the window for which the notification acceptance block has obtained the notification information is active; a pop-up message display block for displaying a pop-up message corresponding to the notification information related to the window if the window status confirmation block confirms that the window is active; and a notification icon display block for displaying a notification icon corresponding to the notification information of the window on the screen of the active window if the window status confirmation block confirms that the window is inactive.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view showing the concept of the present invention applied to embodiments.

FIG. 2 shows an example display screen when an event occurs in an inactive window.

FIG. 3 is a view showing an example integrated window display screen of a first embodiment.

FIG. 4 is a block diagram showing the hardware configuration of an information processing apparatus to which the first embodiment is applied.

FIG. 5 shows the software configuration of the first embodiment.

FIG. 6 shows an example notification table of the first embodiment.

FIG. 7 shows an example notification history display window displayed in the first embodiment.

FIG. 8 is a flow chart showing a general procedure of message display control of the first embodiment.

FIG. 9 is a view showing a procedure of child window processing in a second embodiment.

### DESCRIPTION OF THE PREFERRED EMBODIMENTS

Embodiments of the present invention will be described below with reference to the drawings. The concept of the invention applied to the embodiments will be described first. Then, the individual embodiments will be described in further detail.

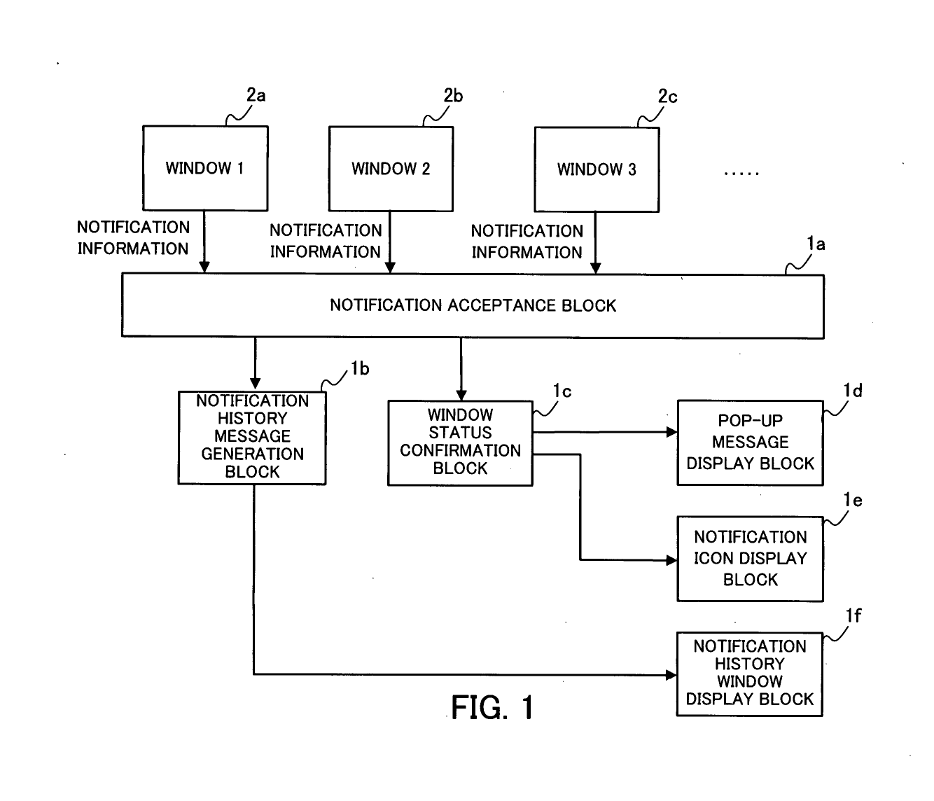

FIG. 1 is a view showing the concept of the present invention applied to the embodiments.

A message display control apparatus according to the present invention includes a notification acceptance block 1a, a notification history message generation block 1b, a window status confirmation block 1c, a pop-up message display block 1d, a notification icon display block 1e, and a notification history window display block 1f. When a notification that a certain event has occurred is received from window 1 (2a), window 2 (2b), window 3 (2c), or the like, processing to control the display of a message reporting the occurrence to the operator is performed. The processing function of each processing block of the message display control apparatus is implemented when a computer executes a message display control program. The processing function of window 1 (2a), window 2 (2b), window 3 (2c), or the like is implemented when the computer executes the corresponding window processing program. Processing blocks can exchange information data by storing the information data in a common storage block, which is not shown.

Window 1 (2a), window 2 (2b), window 3 (2c), and the like are graphical user interfaces (GUIs) for displaying work data and a message on the screen, depending on their specific processing, and the windows operate in parallel on the computer in accordance with the corresponding window processing programs. Among the plurality of windows operating in parallel, one window becomes an active window having the input focus. If a certain event which must be reported to the operator occurs, the corresponding window generates notification information related to the event and notifies the notification acceptance block la that the event has occurred. In the subsequent description, a window processing block which performs processing in accordance with a window processing program will be referred to as a window, and a window displayed on the screen will be referred to as a window screen.

When a notification that the certain event has occurred is given from window 1 (2a), window 2 (2b), window 3 (2c), or the like, the notification acceptance block la obtains notification information generated by the corresponding window and starts the notification history message generation block 1b and the window status confirmation block 1c. The notification information includes a window identifier, the description of the event, the severity of the event, the date and time of occurrence, and the like, and the notification information is transferred from the window through a common storage block, for instance.

After the notification acceptance block la obtains the notification information, the notification history message generation block 1b generates a notification history message for informing the operator of the event that has occurred in the window, in accordance with the notification information. The notification history message is saved in the common storage block.

The window status confirmation block 1c checks whether the window from which the notification acceptance block 1a has obtained the notification information is active. If the window is active, the window status confirmation block 1c starts the pop-up message display block 1d. Otherwise, the window status confirmation block 1c starts the notification icon display block 1e.

If the window status confirmation block 1c confirms that the window from which the notification information has been obtained is active, the pop-up message display block 1d displays a pop-up message on the screen in accordance with the notification information.

If the window status confirmation block 1c confirms that the window from which the notification information has been obtained is inactive, the notification icon display block 1e displays a notification icon on the active window screen in accordance with the notification information. The notification icon is displayed in the title field or an icon display field of the active window screen, for instance. The display color or shape of the notification icon is selected as predetermined in accordance with the severity of the event that has occurred. Display colors may be determined in accordance with the level of need for action, such as red for a highly important event that requires an immediate action, yellow for an event of intermediate severity and intermediate urgency, and blue for an event of low severity that does not require an immediate action, and a color is selected as predetermined. The notification icon may blink. The display color is selected for a notification of which notification history has not yet been checked by the operator.

When a notification history message display request is entered, the notification history window display block 1f displays a notification history window screen in accordance with the notification history message stored in the storage block and puts out the notification icon. The operator makes a notification history message display request by selecting the notification icon or the like. The notification history message displayed in the notification history window screen and checked by the operator is deleted from the storage block.

The operation of the message display control apparatus configured as described above will next be described.

Window 1 (2a), window 2 (2b), window 3 (2c), and the like perform the corresponding window processing. If an error or a certain event that must be reported to the operator occurs, the window notifies the notification acceptance block la that the event has occurred. At the same time, the window generates notification information of the event that has occurred and stores the notification information in the common storage block.

When a notification that the certain event has occurred is received from a window, the notification acceptance block 1a obtains the corresponding notification information by reading it from the common storage block. The notification history message generation block 1b generates a notification history message in accordance with the notification information and adds the message to notification history message data stored in the common storage block. The window status confirmation block 1c checks the status of the window from which the notification acceptance block la has obtained the notification information. If the window is active, the window status confirmation block 1c starts the pop-up message display block 1d. Otherwise, the window status confirmation block 1c starts the notification icon display block 1e.

If the window where the certain event has occurred is active, the pop-up message display block 1d displays a pop-up message on the screen in accordance with the notification information. Accordingly, if an event that must be reported to the operator has occurred in an active window, a pop-up message appears and notifies the operator of details of the event that has occurred. Because the occurrence of the event in the active window is reported, the operator can take action normally.

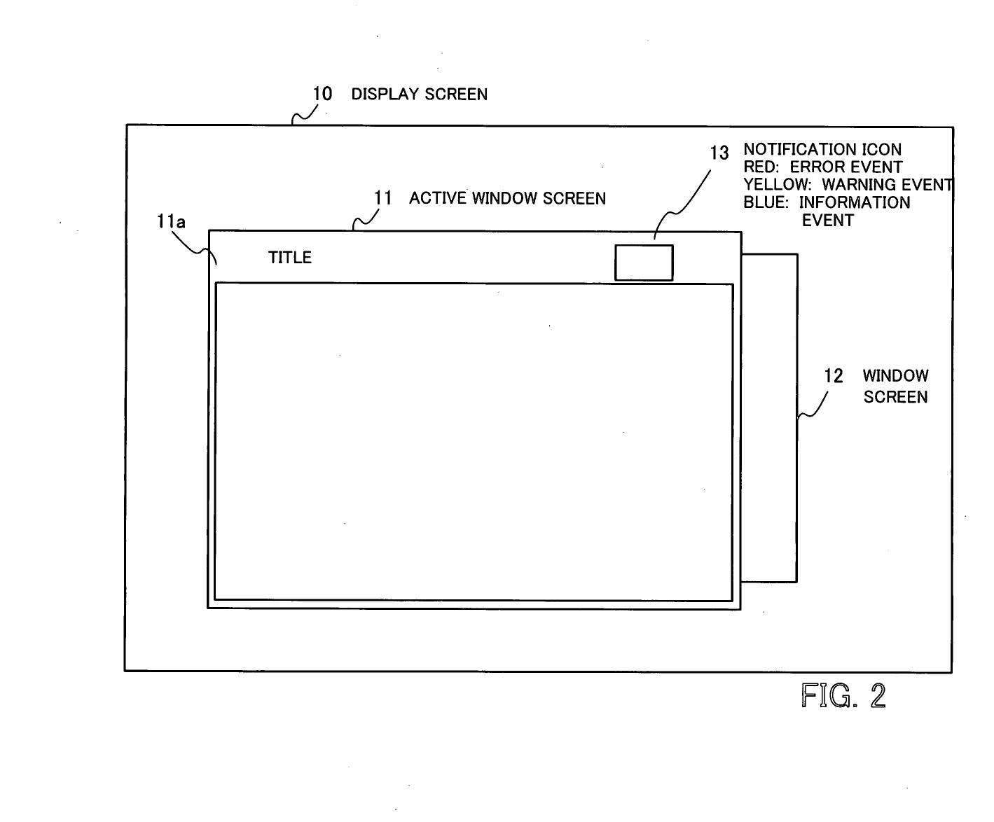

If the certain event occurs in an inactive window, the notification icon display block 1e selects a notification icon corresponding to the severity of the event in accordance with the notification information and displays the icon on the active window screen. If the predetermined display colors of the notification icon are red, yellow, and blue, in descending order of severity, the notification icon of the corresponding display color of severity is displayed on the active window screen. With the notification icon displayed in any place of the active window screen, the operator can know the occurrence and the severity of the event while working with the active window. FIG. 2 shows an example of the display screen when an event occurs in an inactive window.

A display screen 10 displays an active window screen 11 having the input focus and another window screen 12 behind the active window screen 11. Suppose that a certain event occurs in the window displaying the window screen 12 and that the notification acceptance block 1a obtains the notification information. When the window status confirmation block 1c detects that the window displaying the window screen 12 is inactive, the notification icon display block 1e determines the severity of the event in accordance with the notification information and displays a notification icon 13 corresponding to the severity on the active window screen 11. In the shown example, the notification icon is displayed in a title field 11a of the active window screen 11. An error event reporting the occurrence of an error has high severity, and the corresponding display color is red; a warning event giving a warning has intermediate severity, and the corresponding display color is yellow; and an information event reporting the end of processing or the like has low severity, and the corresponding display color is blue. If an error event occurs, a red notification ion 13 is displayed; if a warning event occurs, a yellow notification icon 13 is displayed; and if an information event occurs, a blue notification icon 13 is displayed.

If a notification history message request is made to check the event, by selecting the notification icon 13, for instance, the notification history window display block 1f displays a list of the notification history messages and puts out the notification icon.

While the operator is working with the window, no pop-up message appears even if an event occurs in another window, and the work is not interrupted. When an event which must be checked by the operator occurs in another window, a notification icon is displayed in the active window screen so that the notification can be found easily.

The event reported to the operator remains in the storage block as a notification history message, and the description of the event can be checked even after the pop-up message is closed by mistake.

The embodiments applied to an integrated window including windows and a parent window calling those windows will be described with reference to the drawings.

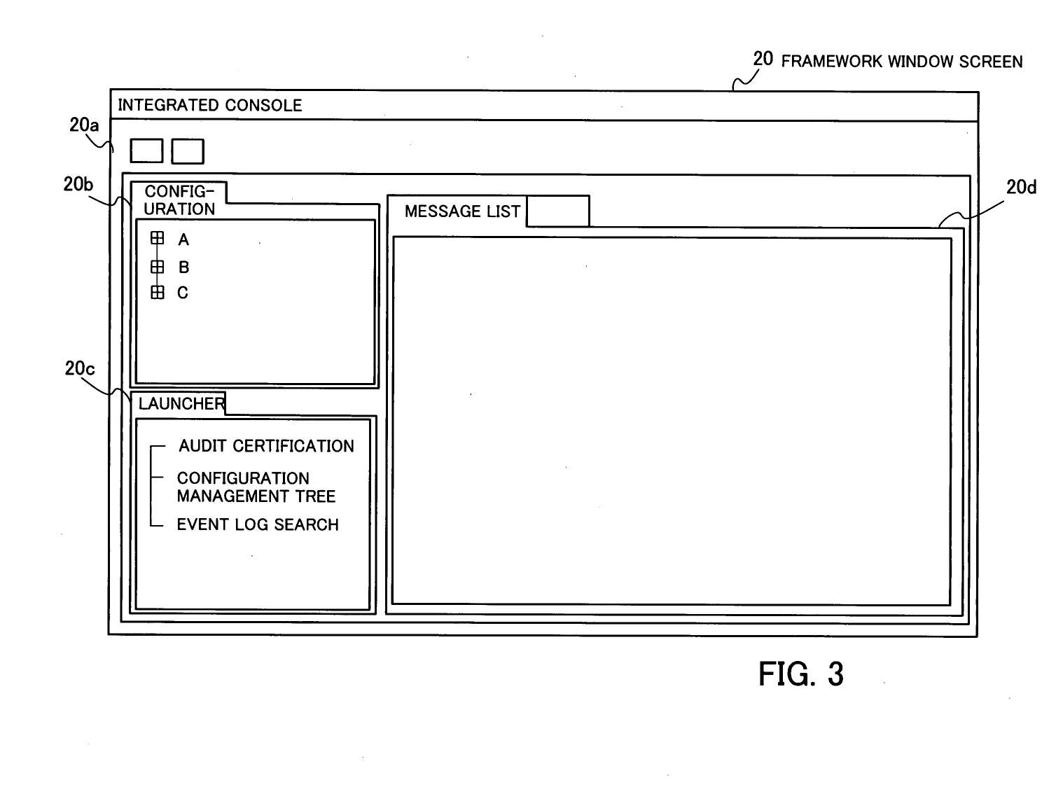

A first embodiment will be described. FIG. 3 is a view showing an example of the display screen of the integrated window of the first embodiment.

A framework window screen 20 displayed by a framework window, which is the parent window, is always displayed on the desktop and has an icon display field 20a, a configuration field 20b, a launcher field 20c, and a child window display field 20d. In the icon display field 20a, icons including a notification icon are displayed. In the configuration field 20b, items that can be selected by the operator are displayed. In the launcher field 20c, operations that can be selected by the operator and the like are displayed. The operator can execute desired processing by selecting an item in the configuration field 20b and the launcher field 20c. The operator can also execute processing by selecting an icon in the icon display field 20a. In the child window display field 20d, child window screens called by the operator's selection in the configuration field 20b are displayed. The child window screen displayed in the forefront of the child window display field 20d is the active window.

Message display control of the first embodiment is applied to an information processing apparatus having the integrated window described above.

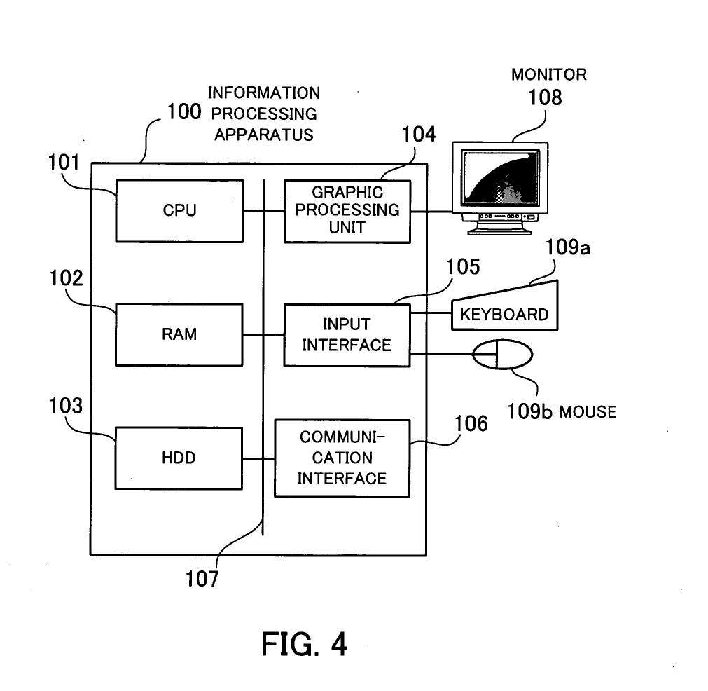

A hardware configuration of the information processing apparatus will be described. FIG. 4 is a block diagram showing an example hardware configuration of the information processing apparatus to which the first embodiment is applied.

An information processing apparatus 100 is controlled altogether by a central processing unit (CPU) 101. The CPU 101 is connected to a random access memory (RAM) 102, a hard disk drive (HDD) 103, a graphic processing unit 104, an input interface 105, and a communication interface 106, via a bus 107.

The RAM 102 stores temporarily at least a part of the OS and an application program executed by the CPU 101. The RAM 102 also stores a variety of data needed for the processing by the CPU 101. The HDD 103 stores the OS and the application program. The graphic processing unit 104 is connected to a monitor 108, which displays an image on the monitor screen as instructed by the CPU 101. The input interface 105 is connected to a keyboard 109a and a mouse 109b and sends a signal sent from the keyboard 109a or the mouse 109b to the CPU 101 through the bus 107. The communication interface 106 is connected to a network, through which data is exchanged with another apparatus.

With that hardware configuration, the processing functions of the first embodiment can be implemented.

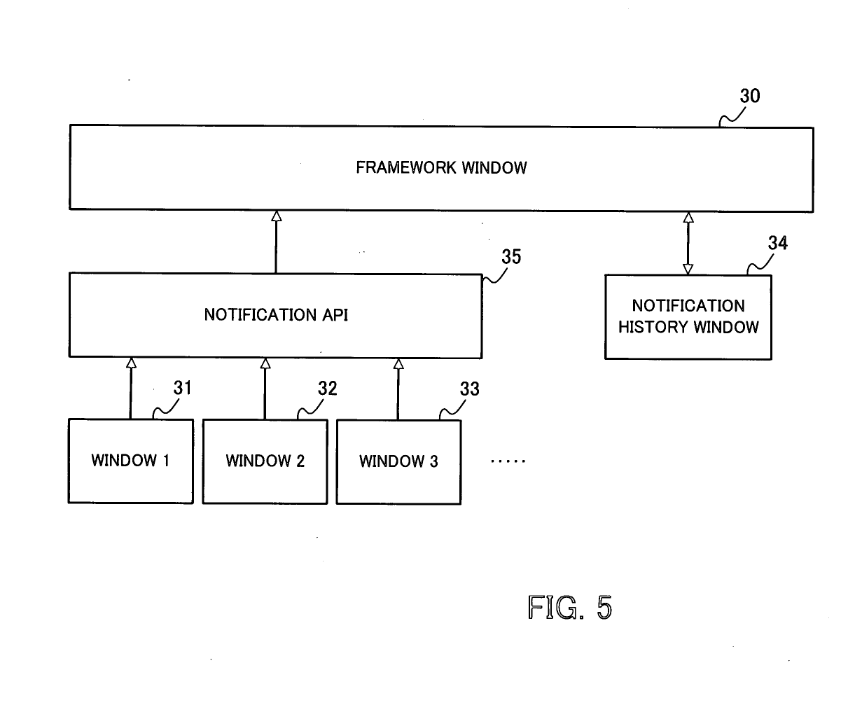

A software configuration will next be described. FIG. 5 shows a software configuration of the first embodiment.

The first embodiment has processing programs of a framework window 30, which is the parent window, window 1 (31), window 2 (32), window 3 (33) and the like, which are child windows of the framework window 30, a notification history window 34 for displaying a notification history message, and a notification application program interface (API) 35 for performing notification from a window to the framework window 30.

The framework window 30 always displays the framework window screen 20 on the desktop and performs processing such as calling a child window, controlling the message display, and generating a notification history message, in accordance with the operator's selection input from the display screen.

Window 1 (31), window 2 (32), window 3 (33), and the like are child windows started from the framework window 30 and execute processing related to a GUI actually operated by the operator. The notification history window 34 performs processing to display a list of notification history messages related to an event which has occurred in the corresponding child window, on the screen. The notification API 35 is started when an event which must be reported to the operator occurs in a child window and notifies the framework window 30 that the event has occurred in the child window.

The framework window 30 activates a child window in accordance with the operator's instruction input through the icon display field 20a, the configuration field 20b, and the launcher field 20c of the framework window screen 20, provides the child window display field 20d to the child window, and displays the corresponding child window screen in the forefront of the child window display field 20d. If it has already been activated, the corresponding child window screen is displayed in the forefront of the child window display field 20d. Now, the child window screen displayed by the child window is displayed in the child window display field 20d. When another child window is requested, the requested child window is started, and the child window display screen of the requested child window is newly displayed in the forefront of the child window display field 20d. The child window activated earlier is not displayed in the forefront, but the processing continues.

Window 1 (31), window 2 (32), window 3 (33), and the like execute their processing. If an event that must be reported to the operator occurs, the window makes a notification to the framework window 30 through the notification API 35. At that time, the child window generates notification information (hereafter referred to as a notification table) related to the event and specifies the table in the common storage block, to give detailed information of the event to the framework window 30.

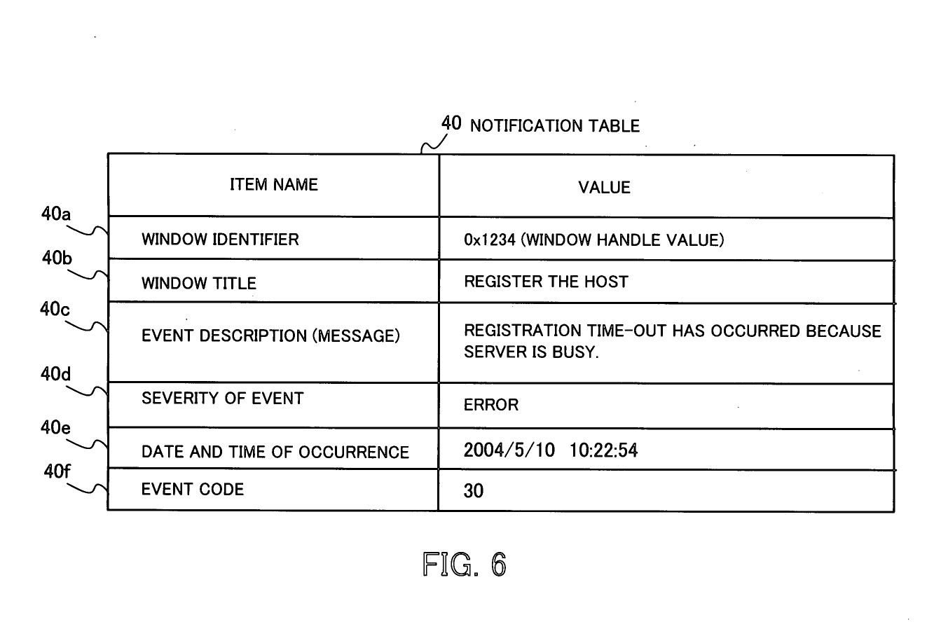

FIG. 6 shows an example of the notification table of the first embodiment. A notification table 40 has values corresponding to items. In the shown example, the notification table 40 has a window identifier 40a for identifying the window, a window title 40b describing the window, an event description (message) 40c describing the event which has occurred, severity of event 40d determining the display color of the notification icon and the like, date and time of occurrence of the event 40e, and an event code 40f representing the event.

The figure shows that a “registration time-out has occurred because the server is busy” event has occurred in a “Register the Host” window (window handle=0×1234); the event is an error; the date and time of occurrence is “2004/5/10 10:22:54”; and the event code is “30”.

When it is informed through the notification API 35 that the event has occurred in the child window, the framework window 30 generates a notification history message related to the event in accordance with the notification table stored in the common storage block and stores the message in the storage block. Then, the framework window 30 checks the child window where the event has occurred. If the child window is the active window which the operator is working with, the event is reported by a pop-up message. If the child window differs from the window which the operator is working with, a notification icon is displayed in any place in the framework window screen 20 to inform the operator of the occurrence of the event alone. The notification icon is displayed in a color corresponding to the severity of the event specified in the notification table so that the severity can be known at first sight. For instance, an error has the highest severity, and a warning and information have the descending levels of severity in that order. Red is selected as the display color of the notification icon for an error event requiring immediate action; yellow is selected as the display color for a warning event; and blue is selected as the display color for an information event, which requires no immediate action, such as an end-of-processing report. When the notification table 40 is received, red is selected as the display color of the notification icon because the severity of the event 40d is an error.

When the operator makes a notification history message display request, the framework window 30 activates the notification history window 34 and displays the notification history window screen in the child window display field 20d.

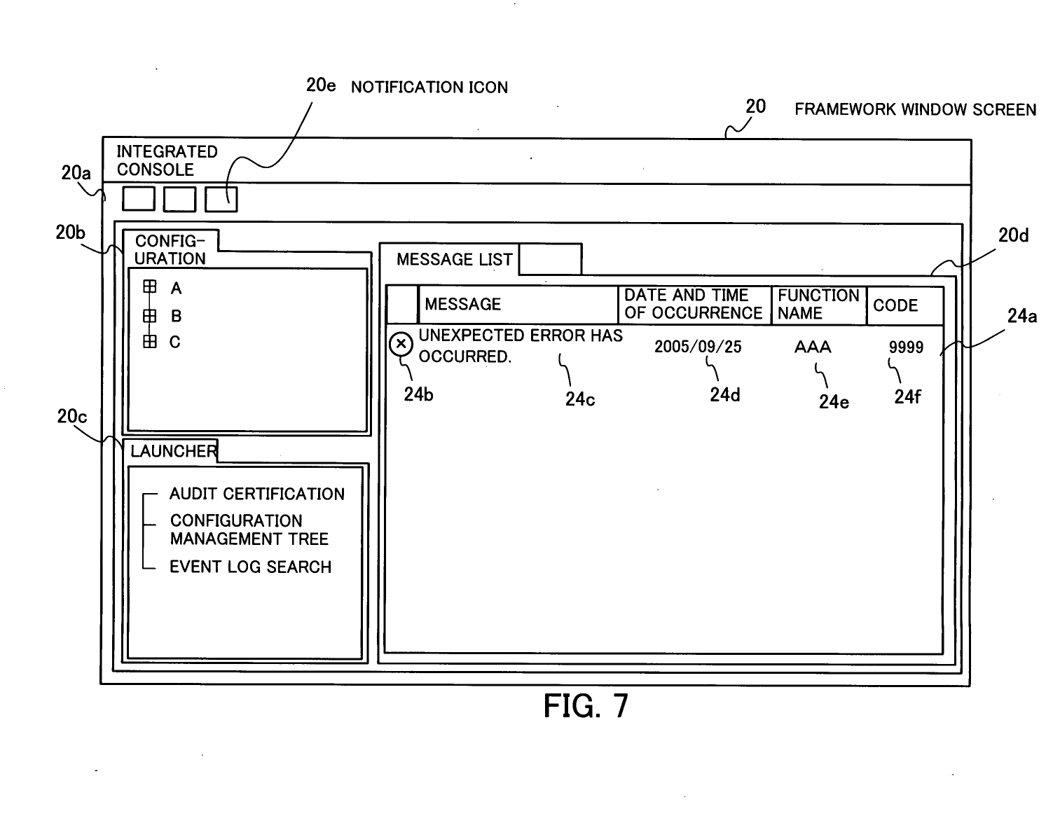

FIG. 7 shows an example of the notification history display window displayed in the first embodiment. The members identical to the members shown in FIG. 3 are denoted by the same reference numerals and will not be described here again.

If a certain event occurs in a child window which is not displayed in the forefront of the child window display field 20d, the child window informs the framework window 30 of the event through the notification API 35. The framework window 30 generates a notification history message related to the notified event, stores the message in the storage block, and displays the notification icon 20e on the framework window screen 20. In the shown example, the notification icon 20e is displayed in the icon display field 20a. The color of the notification icon 20e depends on the severity of the event. The notification icon 20e tells the operator that an event has occurred in an inactive window, together with the severity of the event. Then, if necessary, the operator can make a notification history message display request by selecting the notification icon 20e, for instance.

When the notification history message request is received, the framework window 30 starts the notification history window 34 and provides the child window display field 20d to the notification history window and puts out the notification icon 20e, if necessary.

The notification history window 34 displays a notification history window screen 24a in the child window display field 20d in accordance with the notification history message stored in the storage block. Messages corresponding to any events that have not been checked by the operator are listed on the notification history window screen 24a. In the shown example, an icon 24b displaying the severity of the event, a message 24c, date and time of occurrence 24d, a function name 24e, and a code 24f are displayed in accordance with the notification table related to the event. The icon 24b is selected in accordance with the severity 40d of the event in the notification table 40 shown in FIG. 6. The message 24c, the date and time of occurrence 24d, the function name 24e, and the code 24f display the event description 40c, the date and time of occurrence of the event 40e, the window title 40b, and the event code 40f, respectively.

Details of the event can be checked by calling the notification history window. The notification history message checked by displaying the notification history window screen is deleted from the storage block. If necessary, the operator may be requested to confirm whether to delete the message.

The procedure of message display control in the first embodiment will be described with reference to a flow chart.

General processing will be described first.

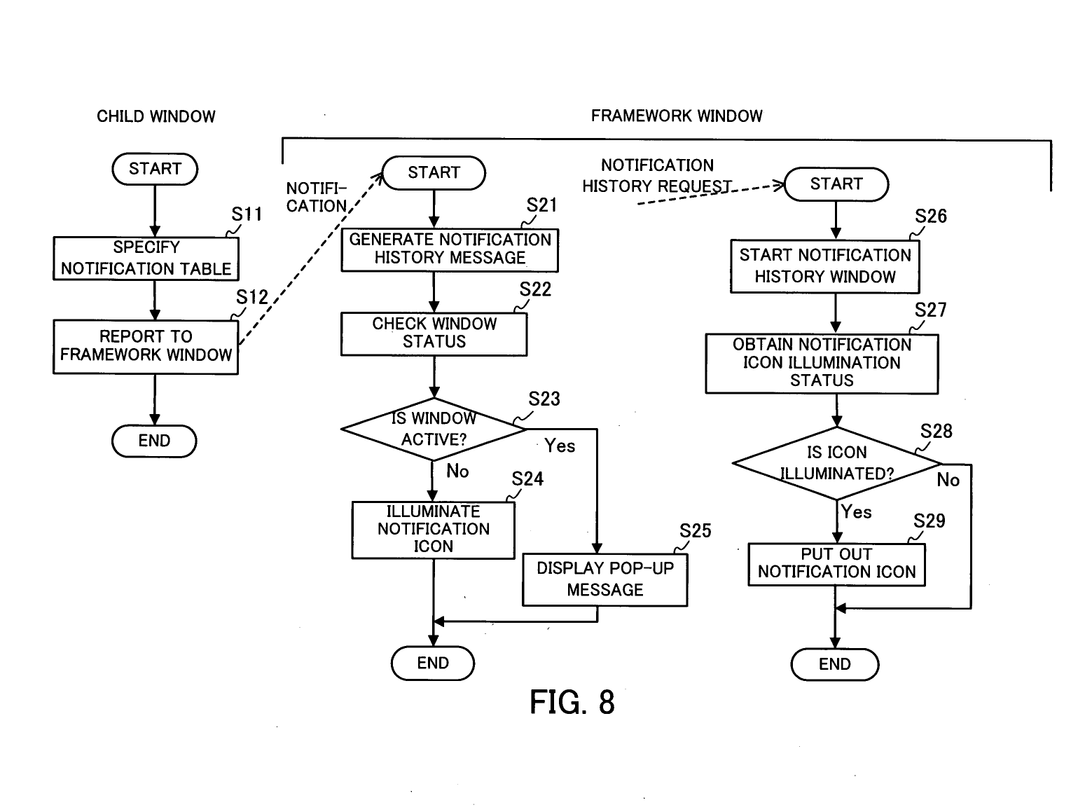

FIG. 8 is a flow chart showing the general procedure of message display control in the first embodiment. The figure shows just steps related to the procedure of message display control in the windows. The processing from when an event that must be reported to the operator occurs until the notification is made to the framework window is shown on the child window side. Shown on the framework side are the processing from when the notification of the occurrence of the event is received from the child window through the notification API until the operator is notified and the processing from when a notification history message display request is received until the message is displayed.

When an event which must be reported to the operator occurs during processing, the child window starts notification processing. [Step S11] A notification table related to the event is generated and stored in the storage block shared with the framework window. In the notification table, the window identifier, the date and time of occurrence of the event, the description of the event, and the severity of the event are specified. Whether the event is an error, a warning, or information is determined and specified as the severity of the event in the notification table, for instance. [Step S12] The notification API is called, and the occurrence of the event is reported to the framework window.

Through the processing described above, the started notification API notifies the framework window that the event has occurred. The framework window starts the message display control processing. [Step S21] A notification history message is generated. The notification table stored in the shared storage block is read, the notification history message of the event is generated in accordance with the contents of the notification table, and the message is added to the message list in the notification history window. The message list information of the notification history window to which the notification history message has been added is stored in the storage block. [Step S22] The window status is checked. The identifier of the window where the event has occurred is obtained on the basis of the notification table read in step S21. The identifier of the active window is also obtained from the OS and is compared with the identifier of the window where the event has occurred. [Step S23] It is judged whether the identifier of the window where the event has occurred matches the identifier of the active window. If the window identifiers match, that is, if the event has occurred in the active window, the processing proceeds to step S25. [Step S24] If the identifier of the window where the event has occurred does not match the identifier of the active window, that is, if the event has occurred in an inactive window, a notification icon is illuminated on the active window screen, and the processing ends. The notification icon is illuminated in a color depending on the severity indicated in the corresponding notification table: red if the event is an error, yellow if the event is a warning, or blue if the event is information. [Step S25] If the event has occurred in the active window, a pop-up message appears to notify the operator that the event has occurred and the processing ends.

With the processing described above, when an event occurs in the active window of which window screen is displayed in the forefront of the child window display field 20d, a pop-up message related to the event appears, and when an event occurs in another window, the notification icon 20e is illuminated to notify the operator that the event has occurred. The operator can receive the notification of the occurrence of the event with the work not being interrupted.

The operator can check the event corresponding to the notification icon 20e or the contents of the pop-up message closed by mistake, by making a notification history message display request (referred to as a notification history request in the figure). When the notification history message display request is entered, the framework window starts notification history window display control processing. [Step S26] The notification history window is started to display the notification history window screen. The notification history window reads the message list information of the notification history window from the storage block and displays the notification history message list in the child window display field 20d. [Step S27] The illumination status of the notification icon is obtained. [Step S28] Whether the notification icon is being illuminated is judged from the obtained illumination status of the notification icon. If the icon is not being illuminated, the processing ends. [Step S29] If the notification icon is being illuminated, the notification icon is put out.

Through the execution of the processing described above, the notification history message list related to the event is displayed. The operator can check the event that has occurred and can take necessary action. Because the message is displayed in the notification history window screen and is reported to the operator, the corresponding notification icon, if being illuminated, is put out.

In the description given above, the processing of steps S27 to S29 is performed by the framework window. The processing may also be performed in the notification history window. In that case, the notification history window cannot directly perform the processing to put out the notification icon in step S29 and will ask the framework window to put out the notification icon.

A second embodiment will next be described.

The pop-up message screen notifies the operator that an event has occurred and asks the operator to do some operation. The operator is given a plurality of possible actions to be taken for the event and asked to select one of the actions, or the operator is asked to confirm that the event has been reported.

In the former case, when the occurrence of the error is reported, a plurality of actions to be taken to handle the error is given, such as “retry the processing” and “stop the processing,” and the operator is requested to select the next step. The processing stops until the operator makes a selection. The processing does not proceed before the operator makes a selection, and the operator should take an early action.

In the latter case, it is checked that the operator has confirmed a notification such as the end of the processing, and just one option such as an OK button is provided. The processing stops until the operator makes a confirmation. The only action that the operator can take in this case is to click the OK button. In many cases, the processing does not need to be stopped until the confirmation is made, and the processing can be continued if the event can be confirmed later.

In the second embodiment, the individual windows continue their processing related to the event, if possible, and notify the operator, taking the message display control procedure of the first embodiment. If an event that must be judged by the operator occurs, a pop-up message appears, calling for an early action by the operator, as before. In the subsequent description, whether the processing can be continued is judged by the number of possible actions that can be taken to handle the event. That is, if there are two or more possible actions, it is judged that the operator's judgment is necessary, and the continued processing cannot be performed. If there is just one possible action, it is judged that the operator does not have another option, and the continued processing is possible.

Members for processing functions in the second embodiment are the same as the members of the first embodiment shown in FIG. 5. The general flow of processing in the second embodiment is the same as that in the first embodiment shown in FIG. 8. Processing performed on the child window side differs from that in the first embodiment.

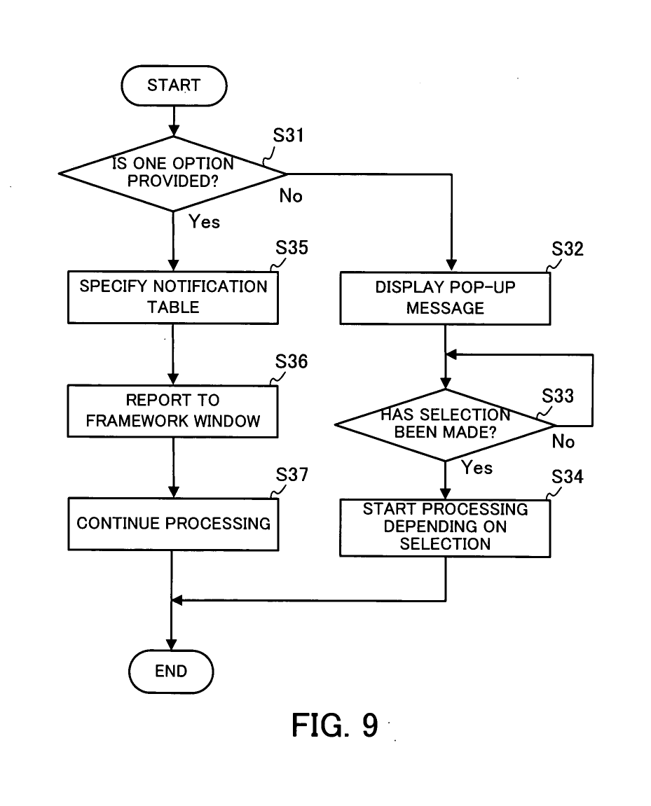

FIG. 9 is a view showing the procedure of child window processing in the second embodiment.

The child window starts notification processing when an event that must be reported to the operator occurs during processing, as in the first embodiment. [Step S31] It is checked whether there is only one possible action to be taken to handle the event. If there is just one possible action, it is judged that the operator's judgment is unnecessary, and the processing proceeds to step S35. [Step S32] If there are a plurality of possible actions to be taken to handle the event, it is judged that the operator's judgment is necessary, and the window processing stops. A pop-up message appears on the screen, indicating information related to the description of the event and the possible actions to be taken, and prompts the operator to make an early selection. [Step S33] It is checked whether the operator has selected the action to be taken. If not, the selection wait state continues. [Step S34] When the action to be taken is selected, the window processing depending on the selection starts, and the notification processing ends. [Step S35] If there is just one possible action to be taken to handle the event, it is judged that the operator's selection is not necessary. A notification table related to the event is generated and stored in the storage block shared with the framework window, to notify the framework window that the event has occurred, as in the first embodiment. [Step S36] The notification API is called, and the framework window is notified that the event has occurred. [Step S37] It is judged that the operator has taken action, the window processing continues, and the notification processing ends.

With the processing described above, if an event that requires the operator's action has occurred, a pop-up message appears and requests the operator to make a selection. This makes it possible to resume the window processing early. If just one possible action is provided such as when the event should be confirmed, the framework window is notified of the event, and the processing continues, as in the first embodiment. The notified framework window performs the processing of the first embodiment shown in FIG. 8. More specifically, a notification history message related to the event is generated; if the event has occurred in the active window, a pop-up message appears on the screen; if the event has occurred in an inactive window, a notification icon is displayed on the active window to notify the operator that the event has occurred. While the operator is working with the window, no pop-up message is displayed even if an event occurs in another window. In addition to the advantage of the first embodiment that the work is not interrupted, the processing of the window where the notification is generated is automatically continued, so that the processing continues even if the operator is not aware of the confirmation message and fails to make a confirmation. The event can be checked later by making a notification history message display request and viewing the list on the notification history window screen, as in the first embodiment.

The processing described above is performed on the window side, but the same processing can be performed on the framework window side. In that case, the child window notifies the framework window of information such as whether there are a plurality of options and whether a pop-up message should be displayed, by adding the information to the notification table. The framework window takes the procedure shown in FIG. 9, in accordance with the notification table, and gives an instruction to start selected processing or to continue the processing to the child window.

The processing functions described above can be implemented by a computer. In that case, a program describing the processing functions that should be included in the message display control apparatus is provided. The processing functions are implemented on the computer when the program is executed on the computer. The program describing the processing can be recorded on a computer-readable recording medium. Computer-readable recording media includes magnetic recording devices, optical disks, magneto-optical recording media, and semiconductor memories. The magnetic recording devices include hard disk drives (HDDs), flexible disks (FDs), and magnetic tapes. The optical disks include digital versatile discs (DVDs) , DVD-random access memories (DVD-RAMs), compact disc read only memories (CD-ROMs), CD-recordables (CD-Rs), and CD-rewritables (CD-RWs). The magneto-optical recording media include magneto-optical disks (MOs).

The program is distributed by selling transportable recording media having recorded the program such as DVDs and CD-ROMS. The program may also be stored in a storage device of a server computer and transferred from the server computer to another computer through a network.

The computer, which executes the program, stores the program recorded on the transportable recording medium or a program transferred from the server computer in its storage device. The computer then reads the program from its storage device and executes programmed processing. The computer can also read the program directly from the portable recording medium and execute the programmed processing. The computer can also execute programmed processing successively each time the program is transferred from the server computer.

In message display control according to the present invention, when an event that should be reported to the operator occurs in the processing of a window, the window status is checked. If the window is active, a pop-up message appears to notify that the event has occurred. The pop-up message relates to the active window having the input focus and will not interfere with the operation of the user. If the event occurs in an inactive window, a notification icon is selected in accordance with the severity of the event and displayed on the active window screen. Because the active window does not change, the generation of the message can be reported together with its severity and urgency, without interfering with the operation of the user.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium having recorded a message display control program for performing display control processing of a message reporting an event which has occurred in a multi-window environment, the message display control program causing a computer to function as:
notification acceptance means for accepting a notification that a certain event has occurred in window processing means for executing processing related to a window and obtaining notification information related to the event, generated by the window processing means;
notification history message generation means for generating a notification history message reporting the event which has occurred in the window, in accordance with the notification information;
window status confirmation means for checking whether the window from which the notification acceptance means has obtained the notification information is active;
pop-up message display means for displaying a pop-up message corresponding to the notification information related to the window when the window status confirmation means confirms that the window is active; and
notification icon display means for displaying a notification icon corresponding to the notification information of the window on the screen of the active window when the window status confirmation means confirms that the window is inactive.

2. The computer-readable recording medium having recorded the message display control program according to claim 1, wherein the notification icon display means executes processing to select a display color of the notification icon specified depending on the severity of the event, in accordance with the severity of the event which has not been confirmed by the operator because the pop-up message or the notification history message has not been displayed.

3. The computer-readable recording medium having recorded the message display control program according to claim 2, wherein the notification icon display means executes processing to select a display color of the highest severity of the event when a plurality of display colors of the notification icon are selected in accordance with the severity of the event.

4. The computer-readable recording medium having recorded the message display control program according to claim 1, wherein the message display control program causes the computer to function also as notification history window display means for displaying a notification history window based on the notification history message on the screen and putting out the notification icon, when a request to display the notification history message is entered.

5. The computer-readable recording medium having recorded the message display control program according to claim 4, wherein the notification history window display means executes processing to judge that the notification history message display request has been made when the notification icon displayed in the active window is operated by the operator.

6. The computer-readable recording medium having recorded the message display control program according to claim 4, wherein the notification history window display means executes processing to delete the notification history message which has been displayed by the notification history window display means and confirmed by the operator.

7. The computer-readable recording medium having recorded the message display control program according to claim 1, wherein the window processing means executes, when an event for which continued processing is specified occurs, processing to notify the notification acceptance means that the event for which continued processing is specified has occurred, while continuing the processing; and
the window status confirmation means checks the window status when the notification acceptance means accepts the notification that the event for which continued processing is specified has occurred; and
the notification icon display means displays the notification icon when the window is inactive.

8. The computer-readable recording medium having recorded the message display control program according to claim 7, wherein the window processing means executes, when an event for which continued processing is not specified occurs, processing to notify the notification acceptance means that the event for which continued processing is not specified has occurred, while interrupting the processing; and
when the notification acceptance means accepts the notification that the event for which continued processing is not specified has occurred, the pop-up message display means displays the pop-up message in accordance with the notification information.

9. The computer-readable recording medium having recorded the message display control program according to claim 7, wherein the event for which continued processing is specified is an event corresponding to a pop-up message including just an option of asking the operator to confirm whether to continue the processing.

10. The computer-readable recording medium having recorded the message display control program according to claim 1, wherein, when the notification acceptance means accepts a notification that an event for which continued processing is specified has occurred, processing to continue the processing is executed by notifying the corresponding window processing means that the operator has responded.

11. The computer-readable recording medium having recorded the message display control program according to claim 10, wherein the event for which continued processing is specified is an event corresponding to a pop-up message including just an option of asking the operator to confirm whether to continue the processing.

12. A message display control apparatus for performing display control of a message reporting an event which has occurred in a multi-window environment, the message display control apparatus comprising:
notification acceptance means for accepting a notification that a certain event has occurred in window processing means for executing processing related to a window and obtaining notification information related to the event, generated by the window processing means;
notification history message generation means for generating a notification history message reporting the event which has occurred in the window, in accordance with the notification information;
window status confirmation means for checking whether the window from which the notification acceptance means has obtained the notification information is active;
pop-up message display means for displaying a pop-up message corresponding to the notification information related to the window when the window status confirmation means confirms that the window is active; and
notification icon display means for displaying a notification icon corresponding to the notification information of the window on the screen of the active window when the window status confirmation means confirms that the window is inactive.
